(19) United States
(12) Patent Application Publication
(10) Pub. No.: US 2014/0242354 A1
(43) Pub. Date: Aug. 28, 2014

(54) ENCAPSULATION FILM WITH THIN LAYER COMPOSED OF GRAPHENE OXIDE AND REDUCED GRAPHENE OXIDE AND METHOD FOR FORMING THE SAME

(71) Applicants: Keun Soo LEE, (US); Jae-Sang RO, Paju-si (KR)

(72) Inventors: Jae-Sang RO, Paju-si (KR); Keun Soo LEE, Seoul (KR); Yong Seok KIM, Seoul (KR); Jin Nam JEON, Seoul (KR); Kwang Joon KIM, Seoul (KR)

(73) Assignees: Jae-Sang RO, Paju-si (KR); Keun Soo LEE, Seoul (KR)

(21) Appl. No.: 14/191,451

(22) Filed: Feb. 27, 2014

(30) Foreign Application Priority Data
Feb. 27, 2013 (KR) 10-2013-0020975

(51) Int. Cl. B32B 27/06; B32B 38/00; B32B 38/10

(52) U.S. Cl. CPC B32B 27/06; B32B 38/10; B32B 38/145
USPC 428/195.1; 428/411.1; 428/339; 428/220; 428/401; 156/231

(57) ABSTRACT

Provided are an encapsulation film formed by stacking at least one bilayer including a thin layer composed of graphene oxide or reduced graphene oxide and an organic polymer layer and a method for forming the same. Since the encapsulation film is formed by stacking at least one bilayer including a thin layer composed of graphene oxide or reduced graphene oxide, the encapsulation film can represent an excellent blocking property with respect to oxygen and moisture. Parallel diffusion of the oxygen and the moisture in the encapsulation film may be significantly limited by maximizing a thickness of the organic polymer layer formed between the thin layers.

### BACKGROUND OF THE INVENTION

1. Field of the Invention

The present invention relates to an encapsulation film including a thin layer composed of graphene oxide or reduced graphene oxide and a method for forming the same, and more particularly, to an encapsulation film formed by stacking at least one bilayer including a thin layer composed of graphene oxide or reduced graphene oxide and an organic polymer layer and a method for forming the same.

2. Description of the Related Art

In general, a device such as an organic solar cell or an organic light emitting device is manufactured on a glass substrate or a plastic substrate. In the OLED, an anode pattern configured by an Indium Tin Oxide (ITO) is formed on a surface of the glass substrate or the plastic substrate. A hole injection layer (HIL), a hole transport layer (HTL), an emitting layer (EML), an electron transport layer (ETL), and an electron injection layer (EIL) made by an organic material are sequentially formed on a surface of the anode pattern. A metal thin film pattern for an anode having a property where electrons are easily injected due to a low work function is formed on a surface of the organic layer so that a sectional structure is configured. In some cases, among the multi-structures, an injection layer and a transport layer may be currently integrated with each other in one layer or a transport layer having a multi-layered structure may be currently used. That is, variously modified structures have been used.

However, some organic layer material and a metal thin film material for an anode used for the OLED react with air or moisture in the atmosphere, thereby forming oxides or hydrates, so that Luminescence properties of the OLED is degraded. For example, aluminum widely used as the metal thin film material for an anode causes the oxidation reaction with oxygen penetrating in the atmosphere. An oxide layer produced by the oxidation reaction interrupts injection of electrons at an interface between the organic layer and the metal thin film layer for the anode. Accordingly, light is not emitted in a part through current flows, and emission efficiency of the device is reduced in a part in which a contact resistance is increased.

Accordingly, various schemes for penetrating the oxygen and the moisture in the device to prevent the performance of the OLED from be degraded have been presented and used.

First, a scheme of sealing a glass material with a low-melting point by heating the glass material in a general OLED using upper and lower glass substrates is used. Since both of a substrate material and a sealing material use a material with almost no transmittance with respect to oxygen and moisture, the first method is known as a method of effectively preventing the OLED from being degraded, and has been successively used for a small OLED.

However, since a sealing rate is low in the low melting point glass laser sealing method, an investment cost of the device is increased so that a manufacturing cost is increased. Since a periphery of a sealing seam line is heated to a high temperature to degrade an organic material constituting pixels, the pixels may be formed around the seam line. Further, since a sealing seam line formed by the low melting point glass laser sealing method has a low sealing strength, in a case of a large panel, a sealing property is easily damaged due to a bending stress and an impact force such as fall of a panel. In addition, since the sealing method uses a low melting point glass, it is difficult to apply the sealing method to a flexible OLED using a polymer substrate such as a PolyEthylene Naphtalate (PEN) substrate, a PolyEthylene Teraphtalate (PET) substrate, a PolyCarbonate (PC) substrate, a polysulfones (PS) substrate, a polyether sulfones (PES) substrate, a polyurethanes substrate, a polyamides substrate, a polyvinyl butyral substrate, a polyvinyl chloride substrate, a polyvinylidene difluoride substrate, and a polyethylene sulfide substrate.

Accordingly, instead of the low melting point glass laser sealing method, a method of sealing upper and lower substrates using an epoxy-based adhesive has been designed and provided. When the adhesive is used as a sealing material, since an adhesion property between substrates is better than that of a glass material, fracture resistance is excellent against the bending stress or the impact force of the OLED, productivity is excellent, the sealing method is applicable to a flexible OLED using a polymer substrate such as a PEN substrate, a PET substrate, a PC substrate, a PS substrate, a polyether sulfones (PES) substrate, a polyurethanes substrate, a polyamides substrate, a polyvinyl butyral substrate, a polyvinyl chloride substrate, a polyvinylidene difluoride substrate, and a polyethylene sulfide substrate.

However, transmittance of the epoxy-based adhesive used in the encapsulation scheme with respect to oxygen and moisture is significantly higher than that of a glass encapsulation material, a structure of the display device and a secondary encapsulation material for preventing oxygen and moisture penetrating through the encapsulation material from being diffused into an OLED has been provided and adopted.

As a representative example of the secondary encapsulation material, a multi-layer encapsulation film having a structure in which bilayers including an organic layer and an inorganic layer are alternately stacked is disclosed in U.S. Pat. No. 7,648,925. The organic layer of the bilayer with polyacrylate serves to apply flexibility to a film by decoupling defects including pin holes formed in an inorganic Al2O3 layer acting as a prevention layer to block diffusion of oxygen and moisture and by attenuating a stress occurring when a film is bent.

As another approach, a tilted function graded film having excellent encapsulation property and mechanical material property by gradually changing a chemical component from a surface to an inner surface is disclosed in U.S. Pat. No. 7,486,020. The tilted function encapsulation material has a structure where a component is continuously changed from a part mainly including a silicon nitride material to a part mainly including a Si-based inorganic polymer.

Although the multi-layer encapsulation film and the tilted function encapsulation film have an excellent sealing property required to be applied to an OLED (see Journal of the SID 13/6, 2005 481), the improvement in following properties is required.

First, in the multi-layer encapsulation film having a multi-layer structure in which bilayers are alternately stacked disclosed in U.S. Pat. No. 7,648,925, an organic layer disposed between inorganic layers has a thickness of about ˜1 μm (see J.-S. Park et al, Semicond. Sci. Technol. 26 (2011) 034001), the horizontal diffusion of oxygen and moisture through the bilayers lowers a gas blocking property of the multi-layer encapsulation film. That is, since diffusion of the oxygen and the moisture through the organic layer depends on a diffusion coefficient of a polymer constituting the organic layer, if oxygen and moisture penetrate from a lateral side of the multi-layer encapsulation film, the oxygen and the moisture are diffused into a layer. Accordingly, since there is no inorganic prevention layer, the polymer is easily diffused into an entire surface of the multi-layer encapsulation film. In this manner, the oxygen and moisture are diffused into the OLED through a defect of the inorganic layer to degrade the performance of the device.

Secondly, a ceramic thin film used as a prevention film material of the encapsulation films is not ductile, it is difficult to perform conformal coating to coat surrounding a concavo-convex surface or a surface of a particle produced during a process. That is, when forming an inorganic layer on the concavo-convex surface or on the surface of a particle by transfer-coating an encapsulation film through a lamination scheme or a deposition process such as a PE CVD, a discontinuous defect of an inorganic layer occurs at a step coverage of the concavo-convex surface or the particle so that an inorganic blocking layer is damaged. Accordingly, a blocking property of the oxygen and the moisture of the encapsulation film is lowered so that light emission of pixels fails.

Finally, since the OLED may present the advantages of light weight and thin thickness, the OLED has been considered as application of a next flexible display. If the two encapsulation films are bent due to a small curvature radius or the two encapsulation films are subjected to a repeated bending work, a ceramic inorganic layer with almost no fracture ductility is fractured and cracked. Accordingly, as another approach unlike the multi-layer encapsulation film and the tilted function encapsulation film, a technique for encapsulating an OLED using a grapheme material is disposed in U.S. Patent Publication No. 2012-0282419.

In U.S. Patent Publication No. 2012-0282419, after a grapheme layer is grown on a surface of a catalyst metal plate such as Cu, the Cu is removed by etching the Cu, a grapheme is laminated on an OLED so that an encapsulation film is formed. Since the graphene has a very low oxygen and hydrogen transmittance, the graphene is greatly applicable as a prevention layer. Since the graphene has a break elongation of about 20%, the grapheme is not cracked due to elongation and bending deformation of a substrate so that the grapheme is applied to a flexible organic substrate to realize a flexible display. In addition, since a grapheme material has a thin thickness of 0.3 nm, conformal coating is possible according to bending of a concavo-convex surface and a particle on a substrate so that most of the above problems can be solved.

However, in a case of the grapheme encapsulation film, a thickness of the grapheme is too thin (0.3 nm), the occurrence possibility of a failure of easily diffusing oxygen and moisture is extremely high during a procedure of growing graphene on a surface of the substrate such as Cu or Ni or a procedure of etching the Cu or Ni substrate to transfer the Cu or Ni substrate on a surface of a large area OLED, productivities of the material and the manufacturing process are low and a manufacturing cost is high. Performances of many devices in addition to the OLED are currently degraded due to oxygen and moisture. Accordingly, there is a need for a technology capable of satisfying the required properties of the encapsulation film.

### SUMMARY OF THE INVENTION

The present invention has been made keeping in mind the above problems occurring in the related art. Inventors of the present invention develop an encapsulation film having a specific structure as described above after performing various searches and experiments. When the encapsulation film is used, high stability, durability, and electric properties of a device can maintain for a long time by preventing oxygen and moisture from penetrating into the device.

According to an aspect of the present invention, there is provided an encapsulation film formed by stacking at least one bilayer including a thin layer composed of graphene oxide or reduced graphene oxide and an organic polymer layer.

A grapheme is a two-dimensional plate material with almost no thickness (˜0.3 nm) including a single atom layer in which a carbon atom is arranged to have a hexagonal shape. It is reported that the grapheme may serve as a diffusion barrier with respect to almost all atoms when no defect is included in the two-dimensional plate material [Jong Min Yuk et. al., “High-Resolution EM of Colloidal Nanocrystal Growth Using Graphene Liquid Cells”, Science, Vol 336, p 61-64(2012)]. However, since a thickness of the grapheme including one layer is thin, the graphene has a low fraction load resistance and is hydrophobic. Accordingly, in order to coat a large area device with the grapheme, after the graphene is fixed to a surface of an organic substrate, the graphene is separated therefrom and transferred or an organic/graphene bilayer is used as it is. However, since a process step is complicated in the above method, there are limitations to apply the method to a device requiring a large area and low cost encapsulation process.

Accordingly, the present invention provides an encapsulation film including a thin layer composed of graphene oxide or reduced graphene oxide which may perform a water solution process because the encapsulation film has dispersion characteristics in a water solution while representing a physical property and a prevention layer property similar to those of a graphene material.

In detail, the graphene oxide or reduced graphene oxide includes a base surface composed of epoxide ligand and hydroxyl ligand to be hydrophilic, and carboxyl ligand is attached to a lateral side thereof to have dispersion characteristics.

The encapsulation film including a thin layer composed of graphene oxide or reduced graphene oxide according to the present invention represents a blocking property against oxygen and moisture and excellent productivity and an economic feature, and conformal coating for the encapsulation film is possible along a concavo-convex surface of a substrate and a surface of a particle.

For example, the thin layer composed of graphene oxide or reduced graphene oxide may be manufactured by oxidizing a graphite with potassium permanganate (KMnO₄) and deep Sulfur dioxide (H₂SO₄) to obtain graphite oxide, and by performing intercalation and exfoliation procedures on the graphite oxide through a Hummer process (W. S. Hummers and R. E. Offeman, J. Am. Chem. Soc., 1958, 80, 1339). Since various processes in addition to the Hummer process are provided as the oxidation of the graphite and intercalation and exfoliation procedures on the graphite oxide, a thin layer composed of graphene oxide uniformly dispersed in a solution may be manufactured by certain processes.

In this case, the thin layer composed of graphene oxide or reduced graphene oxide may include 1 to 10 graphene layers, preferably, 1 to 5 graphene layers. More preferably, the thin layer composed of the graphene oxide or the reduced graphene oxide may include 1 or 2 graphene layers in order to present a conformal coating performance of a bilayer and an excellent blocking property with respect to oxygen and moisture.

The encapsulation film according to the present invention can decouple defects produced between thin layers by densely arranging a thin layer composed of graphene oxide or reduced graphene oxide having a plate shape larger than a predetermined size on the same plane and coupling the thin layer with an organic polymer layer to form a bilayer and can significantly reduce transmittance of oxygen and moisture in a vertical direction by stacking and arranging at least one bilayer.

Since the diffusion of the oxygen and the moisture into the encapsulation film is achieved through openings formed between thin layers composed of graphene oxide or reduced graphene oxide with a plate shape arranged on the same plane, it is preferable to minimize the number, sizes, and an area ratio of the openings in order to reduce vertical diffusion through the openings formed between the thin layers. The reason for this is that the oxygen and the moisture are easily diffused through openings in which a thin layer serving as a blocking layer composed of the graphene oxide or the reduced graphene oxide is not coated so that it is difficult to ensure a blocking characteristic with respect to the moisture and the oxygen of the encapsulation layer. The number, the size, and the area ratio of the openings are determined depending on the size of the thin layer composed of the graphene oxide or the reduced graphene oxide.

In detail, the size of the thin layer composed of the graphene oxide or the reduced graphene oxide is indicated as a diameter or a width of the thin layer. Since a contact area between the thin layers is reduced as the diameter or the width of the thin layer is increased, an area ratio of openings formed between the thin layer arranged on the same plane is reduced. That is, if the diameter or the width of the thin layer composed of the graphene oxide or the reduced graphene oxide is increased, a blocking property of the encapsulation film according to the present invention is improved.

Accordingly, in one concrete example, a diameter or a width of a thin layer composed of the graphene oxide or the reduced graphene oxide included in the thin layer may be 1 μm or greater, preferably, be 10 μm or greater.

Further, as the stack number of bilayers is increased, the oxygen and moisture blocking property is improved. Accordingly, the stack number of the bilayers may be 1 to 10, preferably, 3 to 7. When the stack number of bilayers is too many, a process time becomes long to lower productivity, transmittance of visible light, and a conformal coating performance, and to increase a manufacturing cost.

Further, the encapsulation film can reduce a diffusion sectional area of the oxygen and moisture in a vertical direction and a horizontal direction to improve a blocking property by minimizing a thickness of an organic polymer layer formed between thin layers composed of graphene oxide or reduced graphene oxide.

In one concrete example, the bilayer including the thin layer composed of the graphene oxide or the reduced graphene oxide and an organic polymer layer may have a thickness in the range of 1 nm to 100 nm, preferably, of 1 nm to 10 nm, and more preferably, of 3 nm to 6 nm.

As described above, in the encapsulation film having a bilayer with a thickness of about several nm, horizontal diffusion of the oxygen and moisture through an organic polymer layer having a thickness thinner as compared with that in vertical diffusion through openings formed between thin layers composed of graphene oxide or reduced graphene oxide having a plate shape arranged on the same plane becomes a rete-determining to control movement of a material. Accordingly, as described above, transmittance of the oxygen and moisture in the encapsulation film maintains constant so that an excellent blocking property with respect to the oxygen and the moisture may be provided by maintaining a thickness of the bilayer constant and by stacking the various number of bilayers.

In one concrete example, the organic polymer layer may use polymer which has a low solubility with respect to the oxygen and the moisture, has an excellent blocking resistance where a density is high so that a diffusion coefficient of the oxygen or the moisture is small, and has an excellent adhesion strength with a thin layer in order to effectively represent a blocking property. Polymer is not specially limited if the polymer has the above properties. For example, the polymer may include one selected from the group consisting of hydrogen-based polymer, parylene-based polymer, a cellulose-based polymer, polyvinyl alcohol (PVA), a polystyrene, polyester, polyvinyl chloride (PVC), SBR, latex-based polymer and a combination of at least two thereof.

Further, since various monomers with at least two functional groups capable of forming crosslinking bond may be used as a material for the organic polymer layer, acrylate-based resin, epoxy-based resin, and unsaturated resin having multi-functional groups may be used. Using the polymer, after a coating layer is formed using a general coating scheme, that is, flash evaporation coating, roll coating, spray coating, or electrostatic spray coating, an organic polymer layer including the monomer is formed by inducing a crosslinking reaction through a curing reaction by UV, plasma, and electron beam.

In accordance with an aspect of the present invention, a method of forming the encapsulation film on a device, the method includes: (i) forming a bilayer including a thin layer composed of graphene oxide or reduced graphene oxide and an organic polymer layer on a porous base; (ii) transferring the bilayer on a surface of the device.

As described above, so as to maximize a blocking property of oxygen and moisture in a vertical direction, it is preferable to form a thin layer with densely arranged thin layers so that openings formed between thin layers composed of graphene oxide or reduced graphene oxide may be miniaturized.

Accordingly, in one concrete example, step (i) may be performed using an electrostatic attraction between the thin layer composed of graphene oxide or reduced graphene oxide and the organic polymer layer or may be performed by forming the thin layer composed of graphene oxide or reduced graphene oxide on a porous base by a suspension casting process and forming the organic polymer layer on the thin layer.

A method of using the electrostatic attraction uses the attraction between a polymer material representing a positive charge and a thin layer composed of graphene oxide or reduced graphene oxide representing a negative charge.

According to this method, since the thin layer composed of graphene oxide or reduced graphene oxide representing a negative charge by the electrostatic attraction is attracted to a surface of a base representing a positive charge by polymer to form a coating surface, if a time required when the thin layer reaches the surface of the organic polymer layer elapses, a dense film may be provided without forming openings between the thin layers composed of graphene oxide or reduced graphene oxide.

Accordingly, the polymer is not specially limited if the polymer is ionized in a water solution to represent a positive charge. For example, the polymer may include one selected from the group consisting of poly(styrene sulfonate) (PSS), poly(ethylene imine) (PEI), poly(allyl amine) (PAA), poly(diallyldimethylammonium chloride) (PDDA), poly(N-isopropyl acrylamide (PNIPAM), poly(methacrylic acid) (PMA), poly(vinyl sulfate) (PVS), and poly(allylamine) (PAH) and a combination of at least two thereof.

The suspension casting process is a process where a thin layer composed of graphene oxide or reduced graphene oxide is caught at a surface of a porous base to form a thin layer when a suspension in which a thin layer composed of graphene oxide or reduced graphene oxide is dispersed makes contact with the porous base and is injected into the porous base. According to the suspension casting process, since the suspension is continuously injected into the open porous base, the surface of the porous base may provide a densed film without forming openings between thin layers composed of graphene oxide or the reduced graphene oxide.

In this case, the suspension is injected through the porous base in various schemes in the suspension casting process.

In one concrete example, the suspension casting process may be a process that injects the suspension in which the thin layer composed of graphene oxide or reduced graphene oxide is dispersed into the porous base by capillary pressure.

In this case, a wetting angle of the suspension in which a thin layer composed of graphene oxide or reduced graphene oxide is dispersed may be determined by a combination thereof if the wetting angel of the suspension is 90° or less. Preferably, the wetting angel of the suspension may have the range of 0° to 90°. More preferably, the wetting angel of the suspension may have the range of 0° to 30°.

In another concrete example, the suspension casting process may include a process that injects the suspension in which a thin layer composed of the graphene oxide or the reduced graphene oxide is dispersed into the porous base by forming hydrates through a hydration reaction of the suspension with the porous base.

In this case, the porous base is not limited if the base has a hydrate reaction property greater than a level capable of generating injection flow into the porous base through the hydration reaction with the suspension. A plaster of Paris for the porous base with a pore size in the range of 0.01 μm to 1 •μm may be used as a representative example of the materials having the above properties.

The porous base with a pore size in the range of 0.01 μm to 1 •μm may be manufactured through various materials and manufacturing processes. The porous base with a pore size in the range of 0.01 μm to 1 •μm may include polymer such as polysulfone, polyethersulfone, polyvinylidenfluoride (PVDF), polypropylene, polyethylene, cellulose acetate, polyacrylnitril, and polyamide, a ceramic filter with alumina and zirconia, and a porous metal plate base with a stainless wire.

In another concrete example, the suspension casting process may include a process of guiding injection of a suspension in which a thin layer composed of the graphene oxide or the reduced graphene oxide is dispersed by applying sound pressure to an opposite surface of the porous base making contact with the suspension.

In this case, the sound pressure may be applied in various schemes such as a vacuum pump, and may have the range of 0.99 atm to 10⁻⁶ torr.

In another concrete example, the suspension casting process may include a process of discharging the suspension in which a thin layer composed of the graphene oxide or the reduced oxide is dispersed through the porous base by applying pressure to the suspension. In this case, the pressure may be variously applied using air or hydraulic pressure to have a range of 1 atm to 100 atm.

After the thin layer composed of the graphene oxide or the reduced graphene oxide is formed on the porous base by the suspension casting process, the organic polymer layer may be formed on a surface of the thin layer in various schemes.

In one concrete example, the organic polymer layer may be formed by the electrostatic attraction between the organic polymer layer and the thin layer composed of the graphene oxide or the reduced graphene oxide. That is, the organic polymer layer may be formed by immersing a thin layer representing a negative charge in a solution in which a polymer material representing a positive charge is melted by the electrostatic attraction.

In another concrete example, the organic polymer layer may be formed by evaporating organic monomer or oligomer constituting the polymer in a molecule state and concentrating and polymerizing the evaporated organic monomer or oligomer on a surface of the thin layer composed of the graphene oxide or the reduced graphene oxide. The process of evaporating the organic monomer or oligomer into the molecule state is not limited, but various processes such as flash evaporation may be used.

In another concrete example, the organic polymer layer may be formed by printing a solution in which polymer is melted on a surface of a thin layer composed of graphene oxide or reduced graphene oxide to dry the resultant object.

Although a process of printing the polymer solution may include spin coating, table coater method, the present invention is not limited thereto. That is, doctor blade coating, dip coating, and bar-coating, screen coating and inkjet printing may be used.

Meanwhile, the encapsulation film is formed by transferring a bilayer including the thin layer composed of graphene oxide or reduced graphene oxide and the organic polymer layer on a polymer substrate or a device to.

The bilayer is transferred by a lamination process in step (ii), and the lamination process is classified according to a form of a used base.

In one concrete example, the lamination may be achieved by applying mechanical pressure to a flat porous base. The present method is a method of transferring the bilayer including a thin layer composed of graphene oxide or reduced graphene oxide and an organic polymer layer formed on a flat large area porous base on the polymer substrate or the device by laminating the bilayer on the flat porous base.

In another concrete example, the lamination may be achieved by applying mechanical pressure to a hollow cylindrical base. This is a method of making a hollow cylindrical porous base in which a suspension may be injected, forming the bilayer on a surface of the hollow cylindrical porous hollow base by the above process, and laminating the bilayer on a surface of the polymer substrate or the device by applying pressure to the bilayer.

In order to form the bilayer as a multi-layer in the above two processes, the transfer process is repeated by a necessary number of times. That is, the bilayer may be formed to have three layers by repeating the lamination process through the flat porous base or the hollow cylindrical base three times.

Since the encapsulation film is applicable by oxygen of a food, a moisture blocking layer, and corrosion resistant coating of a metal and a ceramic material, the present invention provides a device including the encapsulation film, and the device may include an electronic device, an optical electronic device, an optical device, a light emitting device, an OLED, an organic semiconductor device, an LCD, a solar cell apparatus, a thin film sensor, or a drink vessel.

As described above, since the encapsulation film according to the present invention is formed by stacking at least one bilayer including a thin layer composed of graphene oxide or reduced graphene oxide, the encapsulation film can represent an excellent blocking property with respect to oxygen and moisture. Parallel diffusion of the oxygen and the moisture in the encapsulation film may be significantly limited by maximizing a thickness of the organic polymer layer formed between the thin layers. Since fracture ductility of the graphene oxide or the reduced graphene oxide is high, a conformal coating with respect to the concavo-convex portion is possible.

Further, the method of forming the encapsulation film according to the present invention can reduce a raw material cost of the device and can significantly reduce a manufacturing cost by considerably improving a process yield.

### BRIEF DESCRIPTION OF THE DRAWINGS

The objects, features and advantages of the present invention will be more apparent from the following detailed description in conjunction with the accompanying drawings, in which:

FIG. 1(a) is a schematic view illustrating a bilayer including a thin layer composed of graphene oxide and reduced graphene oxide and an organic polymer layer;

FIG. 1(b) is a schematic illustrating an encapsulation film including a bilayer having a multi-layer structure;

FIG. 2 is a schematic view illustrating a process of forming a bilayer using an electrostatic attraction between a thin layer composed of graphene oxide or reduced graphene oxide and an organic polymer layer;

FIG. 3 is a schematic view illustrating a process of forming the thin layer composed of the graphene oxide or the reduced graphene oxide on a porous base through a suspension casting process;

FIG. 4 is a schematic view illustrating a process of laminating the bilayer formed through the suspension casting process on a polymer substrate or a device;

FIG. 5 is a scanning electron microscope (SEM) photographic view illustrating a bilayer formed by the electrostatic attraction between a thin layer composed of graphene oxide manufactured by a Hummer process and an organic polymer layer composed of PDDA polymer;

FIG. 6 is a graph illustrating variation of an electric conductivity according to a second experimental example of the present invention;

FIG. 7(a) is an SEM photographic view illustrating a plaster base of Paris used as a porous base of the suspension casting process;

FIG. 7(b) is an SEM photographic view illustrating a thin layer composed of graphene oxide formed on a plaster base of Paris by the suspension casting process;

FIG. 8(a) is an SEM photographic view illustrating a filter base with a pore size less than 1 μm used as the porous base formed by the suspension casting process; and

FIG. 8(b) is an SEM photographic view illustrating the thin layer composed of the graphene oxide formed on the filter base by the suspension casting process.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

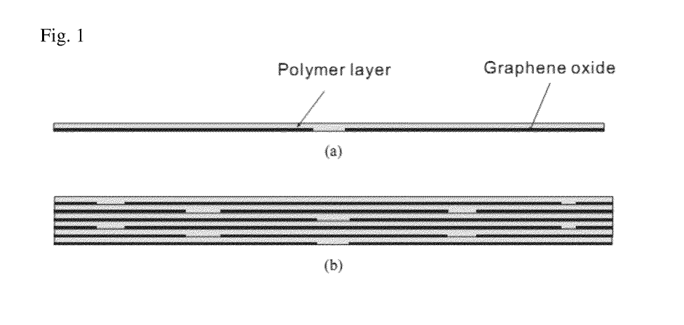

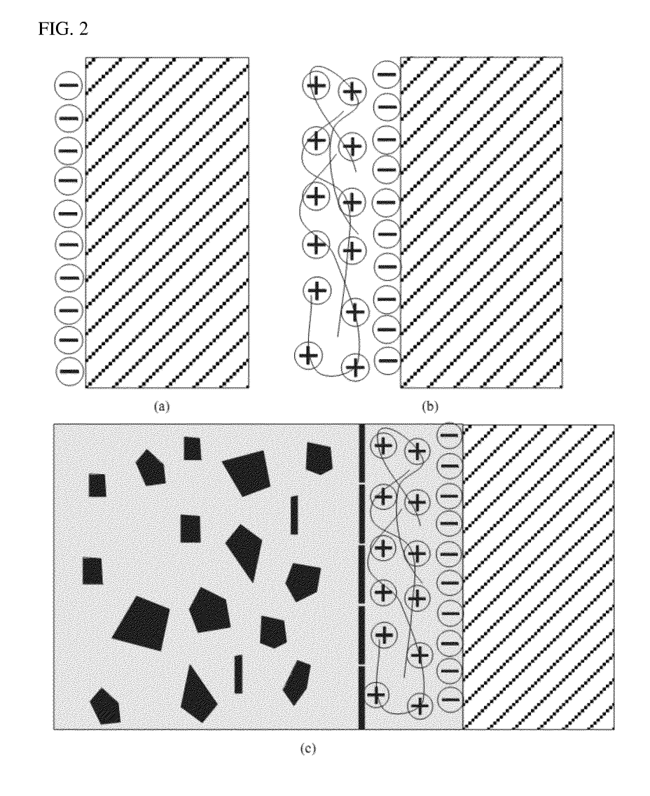

FIG. 1(a) is a schematic view illustrating a bilayer including a thin layer composed of graphene oxide and reduced graphene oxide and an organic polymer layer, and FIG. 1(b) is a schematic illustrating an encapsulation film including a bilayer having a multi-layer structure.

In this case, since it is preferable that the thickness of the organic polymer layer has the thinnest value if the value has a range capable of obtaining an uniform thickness, the bilayer including a thin layer composed of the graphene oxide or the reduced graphene oxide and the organic polymer layer may have the range of 1 nm to 100 nm, preferably, of 1 nm to 10 nm, and more particularly, of 3 nm to 6 nm.

Meanwhile, as shown in FIG. 1(b), a plurality of bilayers may be stacked so that a blocking property with respect to the oxygen and the moisture may be improved. For example, 1 to 10 bilayers, preferably, 3 to 7 bilayers may be stacked.

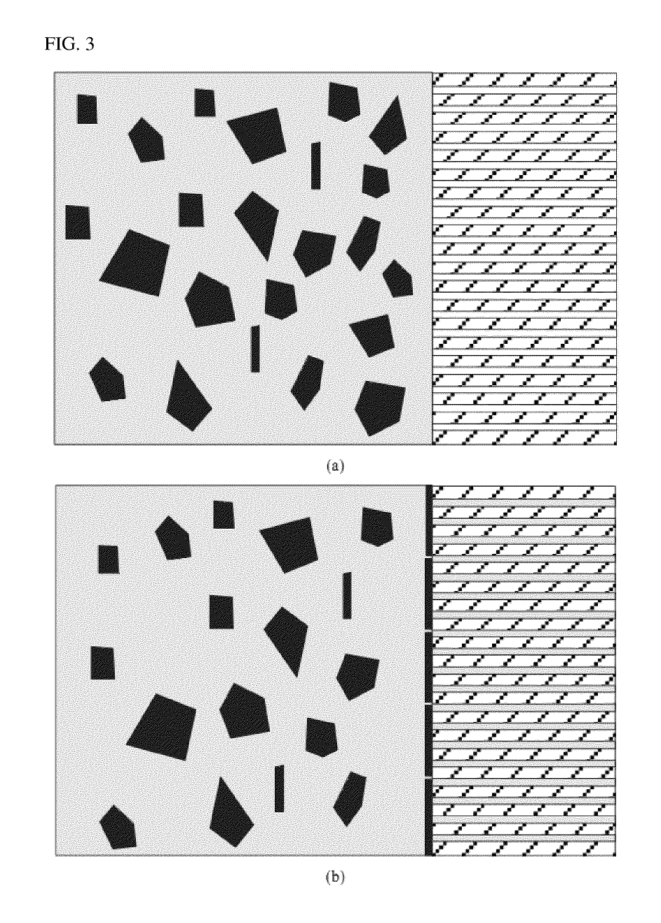

FIG. 2 is a schematic view illustrating a process of forming a bilayer using an electrostatic attraction between a thin layer composed of graphene oxide or reduced graphene oxide and an organic polymer layer, and FIG. 3 is a schematic view illustrating a process of forming the thin layer composed of the graphene oxide or the reduced graphene oxide on a porous base through a suspension casting process.

In detail, referring to FIG. 2, FIG. 2(a) is a schematic view illustrating a procedure of charging a surface of a polymer substrate for a device being a flat based with a positive charge by oxygen plasma processing. FIG. 2(b) is a schematic view illustrating a shape of the organic polymer layer formed between the base and polymer by the electrostatic attraction by immersing the polymer substrate in a solution in which the polymer representing a positive charge is melted. FIG. 2(c) is a schematic view illustrating a shape of a thin layer formed by the electrostatic attraction by immersing a substrate representing a positive charge in a suspension solution including a thin layer representing a negative charge composed of the graphene oxide or the reduced graphene oxide.

The procedure will be described in detail. A layer representing a negative charge is formed on a surface of a substrate by exposing a polymer substrate or a glass substrate including polyethylene naphthalene (PEN), polyethylene terephthalate (PET), polycarbonate (PC), polystyrene (PS), polyethersulfone (PES), polyurethanes, polyamides, polyvinyl butyral, polyvinyl chloride, polyvinylidene difluoride, and polyethylene sulfide to oxygen plasma that allows an oxygen ion to sputter a material surface (FIG. 2(a)). In this case, the oxygen plasma may use DC, AC, and RF energy sources, and the layer representing the negative charge is formed under a condition that the substrate is not permanently damaged due to plasma sputtering.

In this manner, a substrate including a surface representing a negative charge through oxygen plasma surface processing is dissociated in a water solution and is immersed in a water solution in which polymer such as PDDA representing a positive charge for a predetermined time, so that the surface of the polymer substrate is coated with polymer representing a positive charge to have a predetermined thickness by the electrostatic attraction (FIG. 2(b)). Polymer remaining on the surface of the substrate is removed by a rinsing procedure of distilled water. In this case, a material of the polymer is not specially limited if the material of the polymer is ionized in a water solution to represent a positive charge. For example, the polymer may include one selected from the group consisting of poly(styrene sulfonate) (PSS), poly(ethylene imine) (PEI), poly(allyl amine) (PAA), poly(diallyldimethylammonium chloride) (PDDA), poly(N-isopropyl acrylamide (PNIPAM), poly(methacrylic acid) (PMA), poly(vinyl sulfate) (PVS), and poly(allylamine) (PAH).

A substrate having the organic polymer layer representing a positive charge where a charge is inverted is immersed in a suspension in which a thin layer representing a positive charge composed of graphene or reduced graphene oxide for a predetermined time so that a thin layer composed of graphene oxide or reduced graphene oxide is uniformly coated on a surface of the organic polymer layer (FIG. 2(c)). A thin layer remaining on a surface of the coating layer is removed by a rinsing procedure of distilled water.

Since the thin layer with a negative charge composed of graphene oxide or reduced graphene oxide is attracted to a base surface representing a positive charge to form a coating surface, it is necessary to maintain a time required when the thin layer composed of the graphene oxide or the reduced graphene oxide reaches a base surface. The maintenance time is determined depending on a density and a size of the thin layer composed of the graphene oxide or the reduced graphene oxide in the suspension, mobility according to a charged density, and a flow rate of the suspension. If the density of the thin layer in the suspension is increased, since the number of thin layers representing a negative charge composed of the graphene oxide or the reduced graphene oxide located within an operation distance of the electrostatic attraction is increased, a time required to form a thin layer is reduced but a generation possibility of agglomeration due to collision between the thin layers is increased. Accordingly, since it is preferable that the thin layer composed of the graphene oxide or the reduced graphene oxide in the suspension has a density in a predetermined range, the density of the thin layer may be in the range of 0.001 g/mole to 0.5 g/mole, preferably, of 0.01 g/mole to 0.1 g/mole based on the suspension.

Further, in order to effectively accelerate coating of the thin layer composed of graphene oxide or reduced graphene oxide, a time required to form the thin layer is reduced by artificially flowing the suspension so that transfer speed of the thin layer to a surface of a substrate is increased.

Referring to FIG. 3, FIG. 3(a) is a schematic view illustrating an initial state of a porous base immersed in a suspension in which a thin layer composed of the graphene oxide or the reduce graphene oxide is dispersed is injected into the porous base. FIG. 3(b) is a schematic view illustrating a state of a thin layer composed of graphene oxide or reduced graphene oxide dispersed in the suspension densely coated on a surface of a porous base after the suspension is injected into the porous base.

The procedure will be described in detail. In a state that the suspension in which the thin layer composed of the graphene oxide or the reduced graphene oxide is dispersed makes contact with the porous base (FIG. 3(a)), when the suspension including the thin layer composed of the graphene oxide or the reduced graphene oxide is injected into the porous base, the thin layer composed of the graphene oxide is caught at a surface of the porous base so that a thin graphene oxide coating layer is formed (FIG. 3(b)).

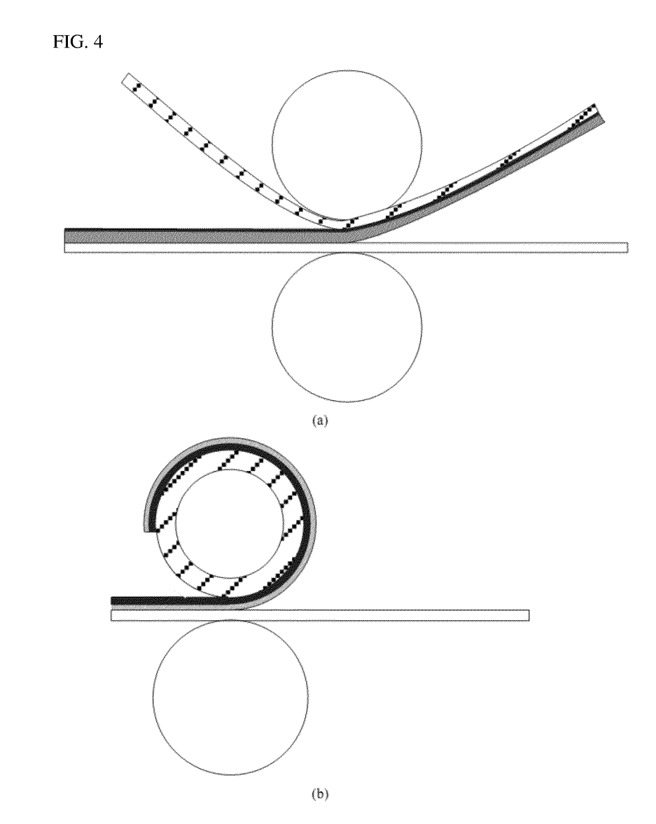

FIG. 4 schematically illustrates a method of laminating and transferring a bilayer by applying mechanical pressure using a roll to a polymer substrate or a device according to the present invention.

In detail, FIG. 4(a) is a schematic view illustrating a process of laminating a bilayer formed on a surface of a flat porous based by a suspension casting process on a surface of a polymer substrate or a device. FIG. 4(b) is a schematic view illustrating a process of laminating a bilayer formed on a surface of a hollow cylindrical porous base by the suspension casting process on a polymer substrate or a device.

Referring to FIG. 4(a), the encapsulation film is formed by transferring the bilayer formed on the flat porous base on the polymer substrate or the device by applying mechanical pressure to the bilayer using a roll for the polymer substrate or the device. In this case, in order to perform conformal coating on the bilayer corresponding to a profile of a shape of a concavo-convex surface or a surface of a particle, the lamination roll may include a coating material such as an elastic rubber having a part which can be deformed. Referring to FIG. 4(b), the encapsulation film is formed by transferring a bilayer formed on a surface of a hollow cylindrical porous base by applying mechanical pressure to the bilayer for the polymer substrate or the device. In the method, so as to guide conformal coating of the bilayer on a concavo-convex surface of the polymer substrate or the device, a concavo-convex portion, and concavo-convex surfaces of particles occurring from a thin film transistor (TFT) of the device, the lamination roll may include a coating material such as an elastic rubber having a part which can be deformed.

Although embodiments have been described with reference to a number of illustrative embodiments thereof, it should be understood that numerous other modifications and embodiments can be devised by those skilled in the art that will fall within the spirit and scope of the principles of the present invention.

### First Experimental Example

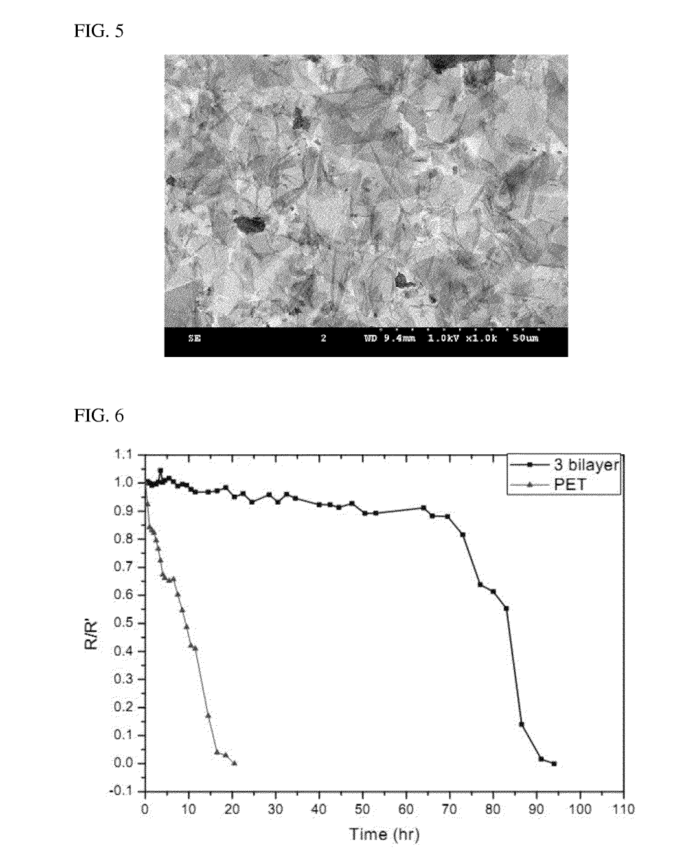

A bilayer is formed on a PET substrate by the electrostatic attraction between a thin layer composed of graphene oxide manufactured by a Hummer process and an organic material composed of PDDA polymer according to a scheme illustrated in FIG. 2, and the thin layer is illustrated in FIG. 5 when observed through a SEM.

As illustrated in FIG. 5, when the bilayer is formed by the electrostatic attraction between a thin layer composed of graphene oxide and an organic polymer layer composed of PDDA polymer, it may be confirmed that a thin layer composed of graphene oxide covers at least 90% of a surface of a PET substrate so that the encapsulation film may represent a necessary blocking property.

### Second Experimental Example

A bilayer according to the first experimental example is laminated to a three layer structure so that a multi-layer encapsulation film is manufactured. A Ca thin film deposited on a glass substrate is covered with a PET substrate coated with the multi-layer encapsulation film. Variation in an electric conductivity of a Ca thin film is measured by exposing a sample to 40° C. 80% RH atmosphere and the measured variation in the electric conductivity of a Ca thin film is illustrated in FIG. 6. Further, for the comparison, after a Ca thin film coated on a glass substrate is encapsulated by a PET substrate which is not coated with the bilayer, variation in the electric conductivity of the Ca thin film is measured and illustrated in the graph of FIG. 6.

Referring to FIG. 6, when the PET substrate which is not coated with the bilayer is used, the electric conductivity of the Ca thin film is rapidly reduced according to an exposure time. In contrast, when the PET substrate coated with a multi-layer encapsulation film, after the electric conductivity of the Ca thin film maintains for a considerable period, the electric conductivity of the Ca thin film is reduced. Since the diffusion of the oxygen and the moisture is determined depending on transient state diffusion through the encapsulation film during the maintenance period of the electric conductivity, transmittance of the moisture through the encapsulation film represents about −10⁻⁴ g/m² day so that a water permeation resistance of the polymer substrate may be significantly improved.

### Third Experimental Example

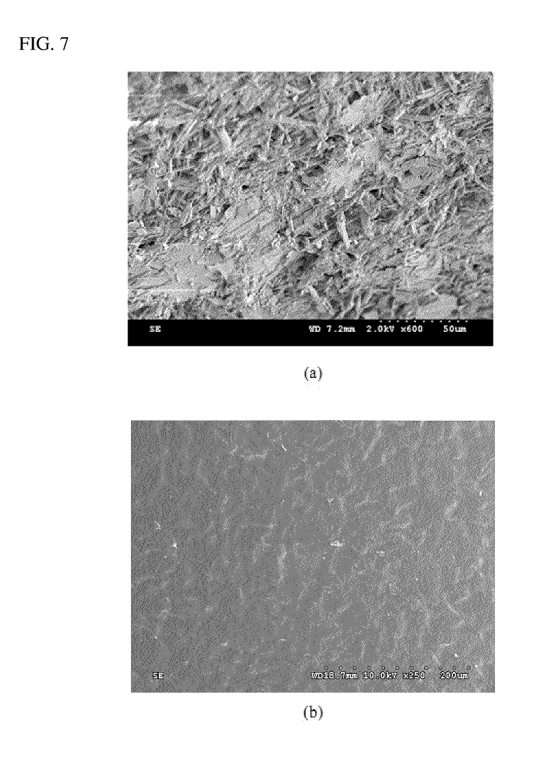

In order to confirm formation of the thin layer composed of the graphene oxide or the reduced graphene oxide using the suspension casting process, a thin layer of 0.05 g/mole composed of the graphene oxide dispersed in the suspension as a porous base reacts with the suspension to form hydrates so that the hydrates are used as a plaster of Paris. External artificial pressure is not applied, and the suspension in which a thin layer composed of graphene oxide is dispersed is injected into a plaster base of Paris for minute. An SEM photograph of the plaster base of Paris before the suspension is injected is illustrated in FIG. 7(a), and an SEM photograph of the plaster base of Paris with the thin layer after the suspension is injected is illustrated in FIG. 7(b).

Referring to FIG. 7, when the thin layer is formed by the suspension casting process using the plaster of Paris, it may be confirmed that a significantly sensed thin layer is formed without the opening between thin layers.

### Fourth Experimental Example

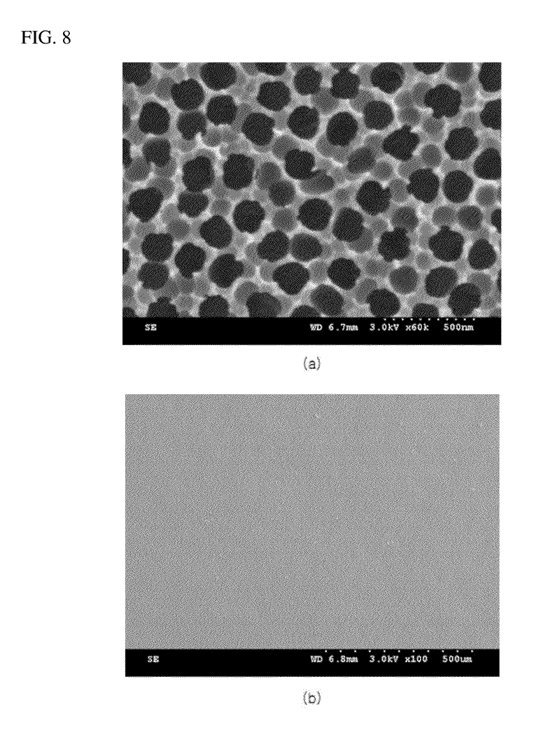

In order to confirm formation of the thin layer composed of the graphene oxide or the reduced graphene oxide using the suspension casting process, a ceramic filter having a small pore of 0.2 μm is used as a porous base so that a thin layer of 0.05 g/mole composed of graphene oxide is filtered from a surface. After the ceramic filter makes contact with the suspension in which a thin layer composed of the graphene oxide is dispersed, the thin layer maintains from 10 minutes so that the suspension is injected through a porous filter base by applying sound pressure of about 0.8 atm to an opposite surface of a ceramic filter base. An SEM photograph of the ceramic filter base before the suspension is injected is illustrated in FIG. 8(a), and an SEM photograph of a thin layer into which the suspension is injected is illustrated in FIG. 8(b).

Referring to FIG. 8, when the thin layer is formed by the suspension casting process using a porous base having a small pore to filter the thin layer composed of the graphene oxide or the reduced graphene oxide dispersed in the suspension from a surface, it may be confirmed that a significantly sensed thin layer composed of the graphene oxide is formed without the opening between thin layers composed of the graphene oxide.

Although embodiments have been described with reference to a number of illustrative embodiments thereof, it should be understood that numerous other modifications and embodiments can be devised by those skilled in the art that will fall within the spirit and scope of the principles of the present invention. The present invention is not limited to the following embodiments but includes various applications and modifications.

What is claimed is:

1. An encapsulation film formed by staking at least one bilayer comprising a thin layer composed of graphene oxide or reduced graphene oxide and an organic polymer layer.

2. The encapsulation film of claim 1, wherein a diameter or a width of a thin layer composed of the graphene oxide or the reduced graphene oxide included in the thin layer is 1 μm or greater.

3. The encapsulation film of claim 1, wherein a thin layer composed of the graphene oxide or the reduced graphene oxide included in the thin layer comprises 1 to 10 graphene layers.

4. The encapsulation film of claim 1, wherein the bilayer comprising the thin layer composed of the graphene oxide or the reduced graphene oxide and an organic polymer layer has a thickness in a range of 1 nm to 100 nm.

5. The encapsulation film of claim 1, wherein the stack number of the bilayers is 1 to 10

6. The encapsulation film of claim 1, wherein the bilayer is formed by an electrostatic attraction between the thin layer and the organic polymer layer.

7. The encapsulation film of claim 1, wherein the bilayer is formed by evaporating organic monomer or oligomer constituting polymer in a molecule state and by concentrating and polymerizing the evaporated organic monomer or oligomer on a surface of the thin layer composed of the graphene oxide or the reduced graphene oxide.

8. The encapsulation film of claim 1, wherein the bilayer is formed by printing a solution in which polymer is melted on a surface of the thin layer composed of the graphene oxide or the reduced graphene oxide to dry the resultant object.

9. A device comprising an encapsulation film according to claim 1.

10. A method of forming an encapsulation film on a device according to claim 1, the method:
(i) forming a bilayer including a thin layer composed of graphene oxide or reduced graphene oxide and an organic polymer layer on a porous base; and
(ii) transferring the bilayer on a surface of the device.

11. The method of claim 10, wherein step (i) is performed using an electrostatic attraction between the thin layer composed of the graphene oxide or the reduced graphene oxide and the organic polymer layer.

12. The method of claim 10, wherein step (i) comprises:
forming the thin layer composed of the graphene oxide or the reduced graphene oxide on the porous base by a suspension casting process; and
forming the organic polymer layer on the thin layer.

13. The method of claim 12, wherein the suspension casting process comprises a process that injects a suspension in which the thin layer composed of the graphene oxide or the reduced graphene oxide is dispersed into the porous based by capillary pressure.

14. The method of claim 12, wherein the suspension casting process comprises a process that injects the suspension in which a thin layer composed of the graphene oxide or the reduced graphene oxide is dispersed into the porous base by forming hydrates through a hydration reaction of the suspension with the porous base.

15. The method of claim 12, wherein the suspension casting process comprises a process that guides injection of a suspension in which a thin layer composed of the graphene oxide or the reduced graphene oxide is dispersed by applying sound pressure to an opposite surface of the porous base making contact with the suspension.

16. The method of claim 12, wherein the suspension casting process comprises a process that discharges a suspension in which a thin layer composed of the graphene oxide or the reduced oxide is dispersed through the porous base by applying pressure to the suspension.

17. The method of claim 12, wherein the organic polymer layer is formed by an electrostatic attraction between the thin layer composed of the graphene oxide or the reduced graphene oxide and the organic polymer layer.

18. The method of claim 12, wherein the organic polymer layer is formed by evaporating organic monomer or oligomer constituting polymer in a molecule state and by concentrating and polymerizing the evaporated organic monomer or oligomer on a surface of the thin layer composed of the graphene oxide or the reduced graphene oxide.

19. The method of claim 12, wherein the organic polymer layer is formed by printing a solution in which polymer is melted on a surface of the thin layer composed of the graphene oxide or the reduced graphene oxide to dry the resultant object.

20. The method of claim 10, wherein step (ii) is performed by a lamination process.
